(19) United States
(12) Patent Application Publication
(10) Pub. No.: US 2014/0102966 A1
(43) Pub. Date: Apr. 17, 2014

(54) Spa Filter Bypass

(71) Applicant: LMI ROTO, LLC, Lake Mary, FL (US)

(72) Inventor: Gary Harder, Lake Mary, FL (US)

(73) Assignee: LMI ROTO, LLC, LAKE MARY, FL (US)

(21) Appl. No.: 13/650,627

(22) Filed: Oct. 12, 2012

(51) Int. Cl. E04H 4/16; B23P 6/00

(52) U.S. Cl. 210/167.1; 29/890.121

(57) ABSTRACT

A filter system includes a conduit for fluidly interfacing to a pump and a shroud adapted to be in fluid communication with a body of water in a spa/tub. A stand pipe has a first end structurally affixed to a bottom surface of the shroud. The first end of the stand pipe is fluidly interfaced to the conduit for transference of water to a pump. A distal second end of the stand pipe has a bypass valve and the stand pipe is sized and positioned within the shroud for holding and supporting a filter media.

This application is related to U.S. design patent application titled Spa Jet Design, attorney docket number 2699.13, filed evendate herewithin. This application is also related to U.S. patent application titled Spa Jet Interface, attorney docket number 2699.10, filed evendate herewithin. This application is also related to U.S. patent application titled Method of Forming Spa Jet Interface, attorney docket number 2699.11, filed evendate herewithin. This application is also related to U.S. patent application titled Improved Spa Jet, attorney docket number 2699.12, filed evendate herewithin.

### FIELD

This invention relates to the field of spa/pools and more particularly to a system for improved filter bypass operation.

### BACKGROUND

Practically every pool, hot tub, and spa has a filter. Periodically, the water in the pool, hot tub, or spa is pumped through the filter to remove small organisms and any other suspended solid materials to clean the water and keep the water clear. There are many types and configurations of filters and an equal number of filter media. For hot tubs and spas, a paper filter is typically fluidly inserted between the skimmer and the pump. The skimmer is typically a waterfall-type device such that any items floating on the water will eventually float over the skimmer and through the filtration system.

As suspended particles are captured in pores of the filter, the ability of water to flow through the filter reduces. Periodically, the filter needs to be changed, cleaned, or backwashed to unclog the pores. The pump will try to move the requisite number of gallons per minute through the filter, independent of the permeability of the filter. If proper maintenance is not performed on the filter, and permeability is reduced beyond a certain point, a filter bypass valve opens to relieve the pressure on the outside surface of the filter and prevent either overload of the pump motor and/or rupture of the filter media.

Many designs use a simple spring-loaded flapper valve between the filter inlet and the pump. The spring is selected to hold the valve substantially closed until a certain pressure is reached, at which time the flapper valve opens and allows water to flow through the bypass, thereby preventing an overload of the pump motor and/or rupture of the filter media.

Being that the bypass valve is typically submerged in the pool/spa water which typically contains an oxidizer such as bromine or chlorine to control biological growth, the bypass valve often clogs or the spring fails, allowing water to freely flow through the bypass valve and, since little or no water flows through the filter, the filter is rendered useless. Repair of the bypass valve is not an easy task. The bypass valve is often located within/beneath the plumbing of the filter enclosure, beneath the filter media holding area and in an area that requires major dismantling in order to access and repair a broken bypass valve.

What is needed is a filter system that will provide robust bypass and improved reparability of the bypass valve.

### SUMMARY

In one embodiment, a filter system is disclosed including a conduit for fluidly interfacing to a pump and a shroud adapted to be in fluid communication with a body of water. A stand pipe has a first end structurally affixed to a bottom surface of the shroud. The first end of the stand pipe is fluidly interfaced to the conduit. A distal second end of the stand pipe has a bypass valve and the stand pipe is sized and positioned within the shroud for holding and supporting a filter media.

In another embodiment, a filter system is disclosed including a shroud. The shroud has an opening for accepting water from a tub/spa and a stand pipe. A first end of the stand pipe is structurally affixed to the shroud. A filter media is mounted on the stand pipe and the filter is fluidly positioned between the shroud opening and the stand pipe. A bypass valve which is normally closed is mounted on and covers a distal end of the stand pipe.

In another embodiment, a method of replacing a failed bypass valve with a replacement bypass valve is disclosed including providing a filter system as described above and removing the strainer from the second end of the stand pipe by unthreading the strainer. Next, the failed bypass valve is removed from the second end of the stand pipe by pulling the failed bypass valve out of second end of the stand pipe. The replacement bypass valve is then installed by pushing the replacement bypass valve into the second end of the stand pipe. The strainer is then replaced on the second end of the stand pipe by threading the strainer onto the threads of the second end of the stand pipe.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a cross sectional view of a typical filter system with bypass valve of the prior art.

FIG. 2 illustrates a plan view of the filter and bypass valve having improved serviceability.

FIG. 3 illustrates an exploded view of the filter and bypass valve having improved serviceability.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

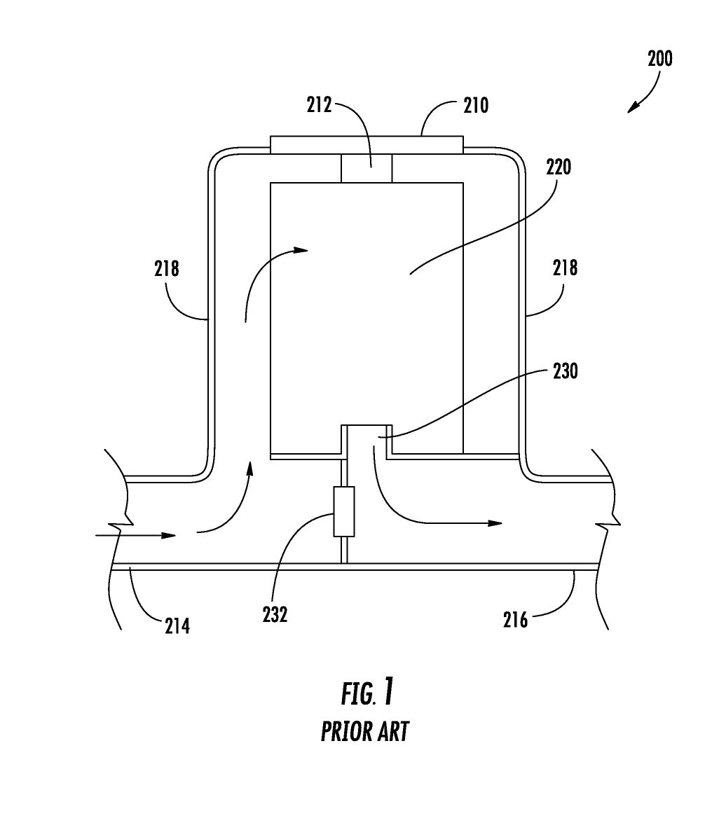

Referring to FIG. 1, a cross sectional view of a typical filter system 200 with bypass valve 232 of the prior art is shown. In this filter system 200 of the prior art, water flows from one or more sources such as a drain that pulls in heavier suspended particles and/or a skimmer that pulls in floating particles (not shown for clarity reasons). The water enters the filter system 200 through an inlet 214. The filter media 220 is held within a filter shroud 218 such that the top opening of the filter media 220 is closed by a plug 212. The plug 212 is typically part of a removable lid 210 that enables removal of the filter media 220 for cleaning and/or for changing the filter media 220. The bottom center hole of the filter media 220 rests on a stand pipe 230. The stand pipe 230 fluidly interfaces the inner area of the filter media 220 with an outlet 216. The outlet 216 is in fluid communication with the pump (not shown).

Water surrounds the filter media 220 and as the pump operates, water is pulled from the center of the filter media 220 and replaced by water surrounding the filter media 220, forcing most of the water to flow through pores in the filter media 220. As particles that are suspended in the water try to pass through the pores (not visible) in the filter media 220, they are blocked and clog the pores of the filter media 220. The particles get lodged in the pores of the filter media 220. The result is clean water (or cleaner water) passes out the outlet 216 to the pump.

As the particulate clogs more and more pores, less open pores are available for the flow of water through the filter media 220. If proper maintenance is not performed such as removal and cleaning of the filter media 220 or replacement of the filter media 220, eventually, less and less water can flow through the filter media 220. As the filter media becomes less and less porous, the suction from the pump creates a greater pressure on the walls of the filter media 220. To prevent the pump from overload and/or a rupture of the filter media 220, many spa systems have a filter bypass valve 232 that is typically held closed by a spring, but at a certain pressure, opens and allows a flow of water from the inlet 214 side to the outlet 216 side of the filter bypass valve 232, thereby reducing the pressure on the clogged filter media 220 and reducing the load on the pump. This reduces cleaning of the water but often saves replacement of a ruptured filter media 220 or a failed pump.

As shown, the filter bypass valve 232 is typically submerged in water, even when the spa is not in use. The filter bypass valve 232 is affected by several materials in this water. First, if the spa water is not maintained correctly, biological material and/or minerals will deposit on the filter bypass valve 232, perhaps causing the filter bypass valve 232 to lock shut or leak. If the filter bypass valve 232 is locked shut, it will no longer protect the pump and the filter media 220. If the filter bypass valve 232 leaks or is stuck in an open position, the filter bypass valve 232 will constantly allow the spa water to bypass the filter media 220 and there will be little or no filtration performed. Another factor is corrosion. To reduce biological material presence in the spa water, an oxidant such as chlorine or bromine is typically added to the water. These oxidants not only destroy microbes, but work continuously against any metal parts to which they are exposed, including the spring of the filter bypass valve 232. Eventually the spring weakens or breaks and the resistance to the filter bypass valve 232 opening subsides and the spa water eventually flows freely through the filter bypass valve 232.

When such failures to the filter bypass valve 232 occur, it is often difficult to replace the filter bypass valve 232 because of its location beneath the filter shroud 218 and filter stand pipe 230. For most existing spas, this becomes a major repair job even though the filter bypass valve 232 is a very low cost item.

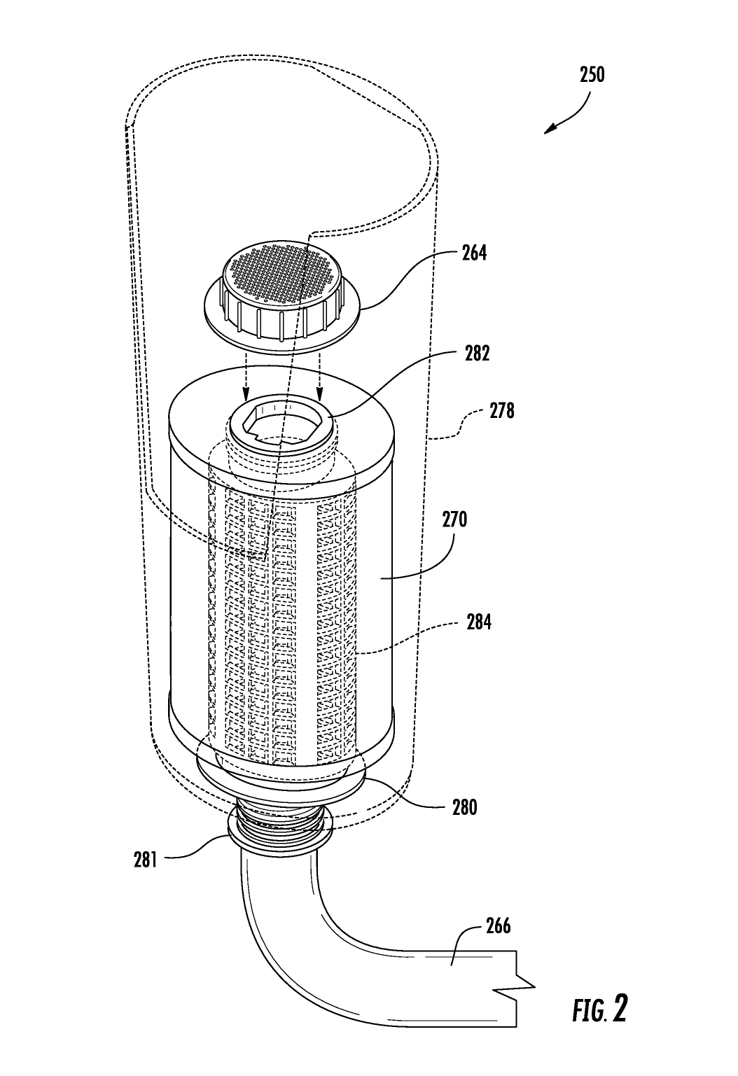

Referring to FIG. 2, a plan view of the filter system 250 with filter media 270 and bypass valve 282 having improved serviceability is shown. In this example, the filter media 270 is surrounded by a shroud 278 such that water flows over a lip of the shroud 278 (e.g. a weir) and surrounds the filter media 270. As water flows through the filter media 270 (e.g. is drawn by the pump—not shown), the water flows through pores of the filter media 270 and through a stand pipe 284 and towards the pump through an outflow pipe 266. A flange 280 in or affixed to a bottom area of the stand pipe 284 maintains a proper position of the filter media 270. The stand pipe 284 provides support and structure for the filter media 270 and also provides support for the filter bypass valve 282 and the optional bypass valve strainer 264.

The filter bypass valve 282 is hinged downwardly in the view of FIG. 2 and is held closed by, for example, spring force or gravity; though any known bypass valve is anticipated. Water substantially surrounds the filter media 270 and as the pump operates, water is pulled from the center of the filter media 270 and replaced by water surrounding the filter media 270, forcing most of the water to flow through pores in the filter media 270. As particles that are suspended in the water try to pass through the pores (not visible) in the filter media 270, they are blocked and clog the pores of the filter media 270. The particles get lodged in the pores of the filter media 270. The result is clean water (or cleaner water) passes out the outlet 266 to the pump.

As the particulate clogs more and more pores in the filter media 270, less open pores are available for the flow of water. If proper maintenance is not performed such as removal and cleaning of the filter media 270 or replacement of the filter media 270, eventually, less and less water can flow through the filter media 270. As the filter media becomes less and less porous, the suction from the pump creates a greater pressure on the walls of the filter media 270. To prevent the pump from overload and/or a rupture of the filter media 270, a filter bypass valve 282 is normally held closed by, for example, a spring. As the pressure increases due to this clogging, the filter bypass valve 282 opens and allows a flow of water from the between the shroud 278 and the outer surface of the filter media 270 through the filter bypass valve 282 and to the outlet 266 and pump. This bypass reduces the pressure on the clogged filter media 270 and reduces the load on the pump. Even though the bypass action reduces cleaning of the water, this bypass often saves replacement of a ruptured filter media 270 or a failed pump.

As shown, the filter bypass valve 282 is typically submerged in and/or exposed to water, even when the spa is not in use. The filter bypass valve 282 is likewise affected by several materials in this water. First, if the spa water is not maintained correctly, biological material and/or minerals will deposit on the filter bypass valve 282, perhaps causing the filter bypass valve 282 to lock shut or leak. If the filter bypass valve 282 is locked shut, it will no longer protect the pump and the filter media 270. If the filter bypass valve 282 leaks or is stuck in an open position, the filter bypass valve 282 will constantly allow the spa water to bypass the filter media 270 and there will be little or no filtration performed. Another factor is corrosion. To reduce biological material presence in the spa water, an oxidant such as chlorine or bromine is typically added to the water. These oxidants not only destroy microbes, but work continuously against any metal parts to which they are exposed, including the spring of the filter bypass valve 282. Eventually the spring weakens or breaks and the closing force of the filter bypass valve 282 subsides and the spa water eventually flows freely through the filter bypass valve 282.

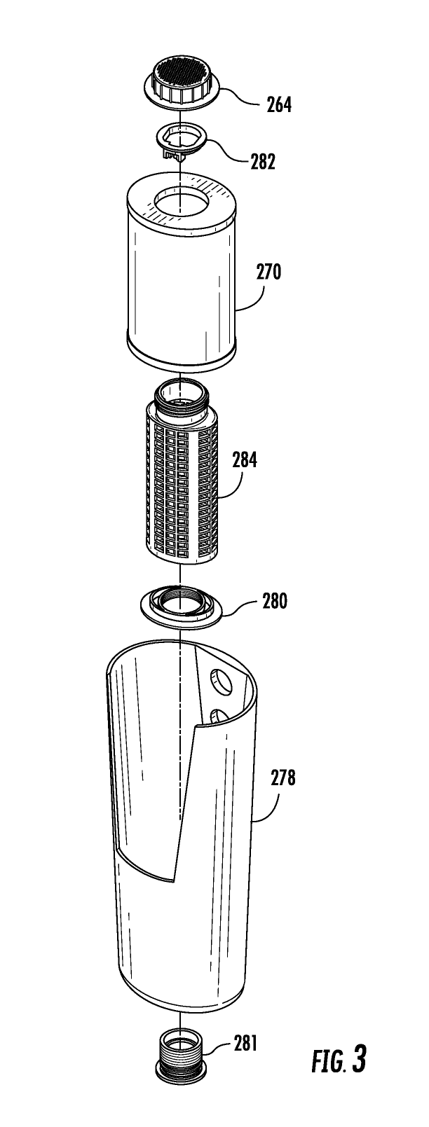

When such failures to the filter bypass valve 282 occur, replacement of the filter bypass valve 282 is simplified by the location of the filter bypass valve 282 atop the standpipe 284. Replacement now becomes a simple task of removing the failed filter bypass valve 282 and installing a new filter bypass valve 282. Any type of retaining mechanism is anticipated to hold the filter bypass valve 282 onto the stand pipe 284, including rotational engagement, threaded engagement, snap engagement, magnetic, fasteners, etc. The retainment mechanism for the filter bypass valve 282 in some embodiments also holds/retains the filter media 270 in place. In the exemplary system shown, the filter media 270 and the bypass valve 282 are held onto the standpipe 284 by threading the strainer 264 onto threads at the top of the stand pipe 284 (as shown in FIG. 3).

In some embodiments, as shown in the examples, the filter media 270 has an oval cross-sectional shape and the stand pipe 284 also has an oval cross-sectional; shape in the area where it mates with the inner wall of the filter medial 270. This oval-shaped filter media 270 provides increased filter surface area (e.g. a greater number of pores) given a certain width over a similar sized filter media that is round. In such, a greater filter area is achieved without increasing the amount of depth required by the filter. In other words, the filter shroud 278 need not protrude as far into the spa using the oval filter media 270 as shown compared with a round filter media 270 (not shown) having equivalent surface area. In other embodiments, any size and shape of filter media 270 is anticipated, including filter media 270 that have round/circular cross sectional shapes and/or irregular shapes.

Referring to FIG. 3, an exploded view of filter system 250 with filter media 270 and bypass valve 282 having improved serviceability is shown.

In this, the general oval cross-sectional shape of the filter media 270 is visible. The flange 280 is attached to a coupling 281, by threads as shown, but any attachment mechanism is anticipated. The flange 280 holds the shroud 278 to the coupling 281 and, subsequently, to the pip/tube 266 (see FIG. 2) that is fluidly coupled to the pump (not shown). The stand pipe 284 attaches to the coupling 281 by any attachment system known, including threads as shown.

The filter media 270 fits over the stand pipe 284. In some embodiments, outer dimensions of the stand pipe 284 are similar to inner dimensions of the filter media 270, such that the inside surface of the filter media 270 rests against the outer surfaces of the stand pipe 284, thereby providing added structure to the filter media 270, especially when the filter media 270 becomes clogged enough as to increase the pressure on the filter media 270.

Although there are many ways to mount the bypass valve 282, in the example shown, a lip of the bypass valve 282 rests on an upper surface of the stand pipe 284 by way of the lip having an outer diameter greater than the inner diameter of the end of the stand pipe 284. The strainer 264 has an inner threaded interface that matches an outer threaded interface of the top end of the stand pipe 284, such that the strainer 264 threads over the outer threaded interface of the top end of the stand pipe 284, thereby secures the bypass valve 282 to the stand pipe 284. Note that the outer diameter of the bypass valve 282 need be small enough such that the strainer 264 will fit over the bypass valve 282. In operation, the filter media 270 is placed over the stand pipe 284, and then the strainer 264 is threaded over the threaded end of the stand pipe 284, thereby retaining the filter media in place. Again, this is an example of one way in which the filter media 270 and bypass valve 282 are properly positioned and connected and any mechanism and architecture is anticipated, producing similar results.

Should the bypass valve 282 fail, the strainer 264 is removed (e.g. unscrewed) and the bypass valve 282 is lifted out of the end of the stand pipe 284. Note that in some embodiments, the bypass valve 282 is held in the end of the stand pipe 284 by any known mechanism, including, but not limited to, threads, press-fit, detents, etc. The new bypass valve 282 is then installed into the end of the stand pipe 284 and the strainer 264 is replaced (e.g. screwed back onto the threaded end of the stand pipe 284).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A filter system comprising:
a conduit for fluidly interfacing to a pump;
a shroud, the shroud adapted to be in fluid communication with a body of water;
a stand pipe, a first end of the stand pipe structurally affixed to a bottom surface of the shroud, the first end of the stand pipe fluidly interfaced to the conduit, a distal second end of the stand pipe having a bypass valve, the stand pipe for holding and supporting a filter media.

2. The filter system of claim 1, wherein first end of the stand pipe is structurally affixed to a bottom surface of the shroud by a flange threaded onto a coupling, the coupling fluidly interfaced to the pump.

3. The filter system of claim 1, wherein a bottom surface of the filter media rests on the flange.

4. The filter system of claim 1, wherein the second end of the stand pipe is threaded and a strainer is threaded onto the second end of the stand pipe, covering the bypass valve.

5. The filter system of claim 1, wherein the side walls of the stand pipe are porous and the side walls of the stand pipe abut against an inside wall of the filter media.

6. The filter system of claim 1, wherein the filter media has an oval cross-sectional shape.

7. The filter system of claim 6, wherein the inside wall of the filter media has an oval cross-sectional shape and the side walls of the stand pipe have a similar oval cross-sectional shape.

8. A filter system comprising:
a shroud, the shroud having an opening for accepting water from a tub/spa;
a stand pipe, a first end of the stand pipe structurally affixed to the shroud;
a filter media mounted on the stand pipe, the filter media positioned between the shroud opening and the stand pipe; and
a bypass valve mounted on and covering a distal end of the stand pipe, the bypass valve normally closed.

9. The filter system of claim 8, wherein first end of the stand pipe is structurally affixed to a bottom surface of the shroud by a flange threaded onto a coupling, the coupling fluidly interfaced to a pump.

10. The filter system of claim 9, wherein a bottom surface of the filter media rests on the flange.

11. The filter system of claim 8, wherein the second end of the stand pipe is threaded and a strainer is threaded onto the second end of the stand pipe, covering the bypass valve.

12. The filter system of claim 8, wherein side walls of the stand pipe are porous and the side walls of the stand pipe abut against an inside wall of the filter media.

13. The filter system of claim 8, wherein the filter media has an oval cross-sectional shape.

14. The filter system of claim 13, wherein the inside wall of the filter media has an oval cross-sectional shape and the side walls of the stand pipe have a similar oval cross-sectional shape.

15. A method of replacing a failed bypass valve with a replacement bypass valve, the method comprising:
providing a filter system according to claim 4;
removing the strainer from the second end of the stand pipe by unthreading the strainer;
removing the failed bypass valve by pulling the failed bypass valve out of second end of the stand pipe;
installing the replacement bypass valve by pushing the replacement bypass valve into the second end of the stand pipe; and
replacing the strainer onto the second end of the stand pipe by threading the strainer onto the threads of the second end of the stand pipe.
